(19) United States
(12) Patent Application Publication
(10) Pub. No.: US 2019/0198222 A1
(43) Pub. Date: Jun. 27, 2019

(54) REACTOR

(71) Applicant: TOYOTA JIDOSHA KABUSHIKI KAISHA, Toyota-shi (JP)

(72) Inventors: Hiroyuki MIYAUCHI, Toyota-shi (JP); Hirotaka KAMIJO, Aichi-gun (JP)

(73) Assignee: TOYOTA JIDOSHA KABUSHIKI KAISHA, Toyota-shi (JP)

(21) Appl. No.: 16/207,321

(22) Filed: Dec. 3, 2018

(30) Foreign Application Priority Data
Dec. 25, 2017 (JP) 2017-248183

(51) Int. Cl. H01F 27/26; H01F 27/28; H01F 27/245; H01F 27/02

(52) U.S. Cl. CPC H01F 27/266; H01F 27/2823; H01F 41/0233; H01F 27/02; H01F 27/245

(57) ABSTRACT

A reactor includes a bobbin around which a coil is wound, and a core extending through the bobbin. The bobbin has a tubular shape. The core has a quadrangular prism shape. The core includes a distal end surface and a pair of side surfaces perpendicular to the distal end surface. The side surfaces are opposite surfaces of the core. The bobbin includes projections respectively provided on inner surfaces of the bobbin. The inner surfaces of the bobbin respectively face the side surfaces of the core. The projections extend in an axial direction of a tubular portion of the bobbin. The projections are in contact with the core.

### INCORPORATION BY REFERENCE

The disclosure of Japanese Patent Application No. 2017-248183 filed on Dec. 25, 2017 including the specification, drawings and abstract is incorporated herein by reference in its entirety.

### BACKGROUND

### 1. Technical Field

The disclosure relates to a reactor. A reactor is a passive element including a coil, and is called “inductor” in some cases.

### 2. Description of Related Art

A reactor includes a bobbin having a tubular shape, a coil wound around the bobbin, and a core extending through the bobbin. An example of such a reactor is described in Japanese Unexamined Patent Application Publication No. 2016-082047 (JP 2016-082047 A).

### SUMMARY

When an angular boundary lies between a distal end surface of a core and a side surface thereof, an edge (i.e., the boundary between the distal end surface and the side surface) of the core may come into contact with a bobbin during insertion of the core into the bobbin, and the edge may be chipped. Typically, when a core is punched out of a magnetic green-compact sintered block, a distal end surface of the core and a side surface thereof become perpendicular to each other, so that an edge is formed at the boundary between the distal end surface and the side surface. A core made through green-compact sintering may be easily chipped, and an edge of the core may be especially easily chipped. The disclosure provides a reactor configured to restrain an edge of a core from being chipped during insertion of the core into a bobbin.

A reactor according to an aspect of the disclosure includes a bobbin around which a coil is wound, and a core extending through the bobbin. The bobbin has a tubular shape. The core has a quadrangular prism shape. The core includes a distal end surface and a pair of side surfaces perpendicular to the distal end surface. The side surfaces are opposite surfaces of the core. The bobbin includes projections respectively provided on inner surfaces of the bobbin. The inner surfaces of the bobbin respectively face the side surfaces of the core. The projections extend in an axial direction of a tubular portion of the bobbin. The projections are in contact with the core. In the reactor, the projections are in contact with the core, and the inner surfaces of the bobbin, which respectively face the side surfaces of the core, are out of contact with the core, except the projections. Thus, edges (i.e., boundaries between the distal end surface and the side surfaces) of the core are less likely to come into contact with the inner surfaces of the bobbin, so that the edges of the core are less likely to be chipped. Note that, only a part of the core to be inserted into the bobbin needs to be in a quadrangular prism shape.

In the above aspect, a height of each of the projections may decrease in a direction toward an opening of the tubular portion. In the vicinity of the opening of the tubular portion of the bobbin, a clearance is left between the core and each projection. Thus, the core can be smoothly inserted into the bobbin.

In the above aspect, the core may include at least two core parts that are a first core part and a second core part, a distal end of the first core part and a distal end of the second core part may face each other inside the bobbin, and the bobbin may include the projections for each of the first core part and the second core part.

The details of the technique described in the present specification and further improvements thereof will be described in “DETAILED DESCRIPTION OF EMBODIMENTS”.

### BRIEF DESCRIPTION OF THE DRAWINGS

Features, advantages, and technical and industrial significance of exemplary embodiments of the disclosure will be described below with reference to the accompanying drawings, in which like reference signs denote like elements, and wherein:

FIG. 1 is a perspective view of a reactor according to an embodiment;

FIG. 2 is an exploded perspective view of the reactor;

FIG. 3 is an enlarged perspective view of a part of a bobbin;

FIG. 4 is a perspective sectional view of the bobbin taken along an alternate long and short dash line IV in FIG. 3;

FIG. 5 is a sectional view of the reactor taken along an alternate long and short dash line V-V line in FIG. 1;

FIG. 6 is a sectional view of a reactor in a first modified example;

FIG. 7 is a sectional view of a reactor in a second modified example;

FIG. 8 is a sectional view of a mold for forming a bobbin in a third modified example;

FIG. 9 is a sectional view of the mold for forming the bobbin in the third modified example (after injection molding); and

FIG. 10 is a sectional view of the mold in an opened state.

### DETAILED DESCRIPTION OF EMBODIMENTS

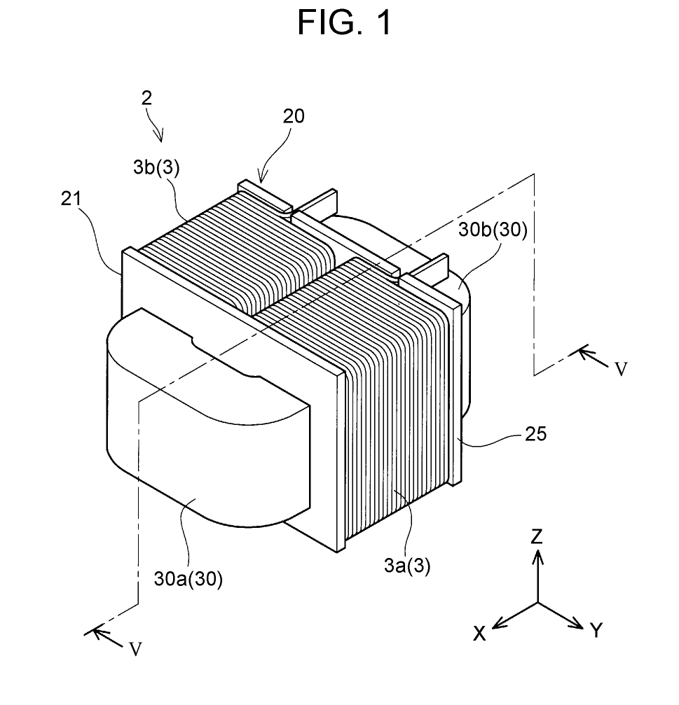

Hereinafter, a reactor 2 according to an embodiment will be described with reference to the accompanying drawings. FIG. 1 is a perspective view of the reactor 2. The reactor 2 is used in a voltage converter configured to boost the voltage of a battery in a drive-train of, for example, an electric vehicle. A traction motor of an electric vehicle is able to output motive power of several tens of kilowatts, and an electric current of several tens of amperes flows out of the battery. Such a high electric current flows through the reactor 2, and thus a flat rectangular wire having a low internal resistance is used as a winding wire. In the following description, for the sake of convenience, the positive direction along the Z-axis in the coordinate system illustrated in the drawings will be defined as “upward” direction, and the negative direction along the Z-axis therein will be defined as “downward” direction.

In the reactor 2, a core 30, which is a magnetic body, extends through a bobbin 20 made of resin, and coils 3a, 3b are attached to the bobbin 20. Each of the coils 3a, 3b is an edgewise coil made of a flat rectangular wire. In some cases, the coils 3a, 3b and the core 30 are covered with a resin cover. However, the resin cover will not be described in the present embodiment.

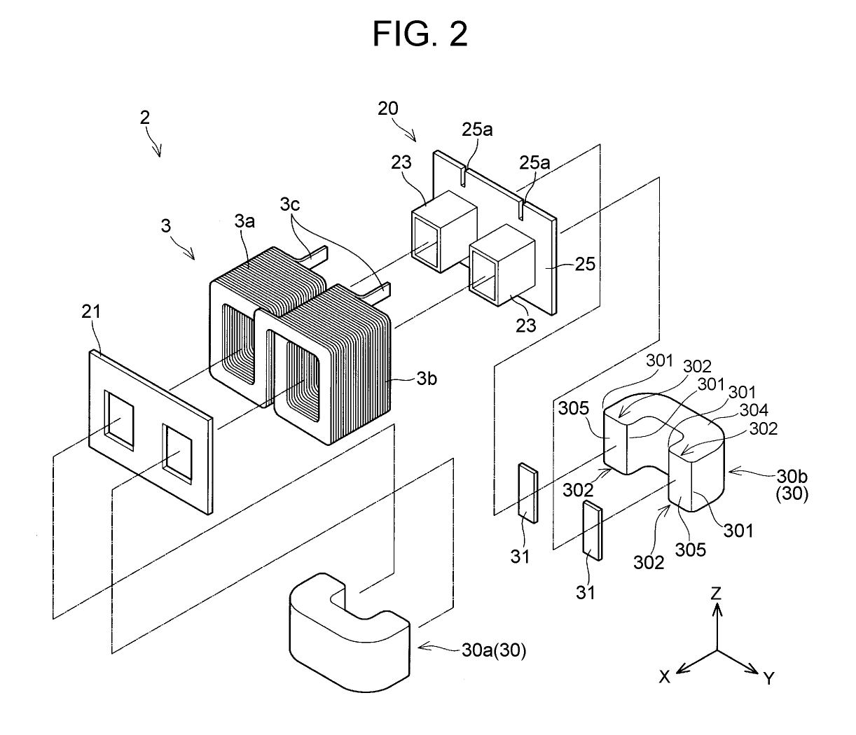

FIG. 2 is an exploded perspective view of the reactor 2. The core includes a pair of core parts 30a, 30b having a U-shape. The core parts 30a, 30b are disposed so as to face each other, so that a core having a loop shape is provided. The core parts 30a, 30b having a U-shape will be collectively referred to as “core 30”.

The core part 30b is produced in the following manner: magnetic particles and resin are mixed together, the mixture is subjected to compression-sintering to form a magnetic green-compact block, and then the core part 30b is punched out of the magnetic green-compact block. A punch block is pushed against a surface of the magnetic green-compact block. The surface of the magnetic green-compact block against which the punch block is pushed corresponds to an upper side surface 304 of the core part 30b. Note that the upper side surface 304 is an example of “side surface”. The magnetic green-compact block is punched into a shape of the core part 30b. Hence, distal end surfaces 305 and the upper side surface 304 meet at a right angle, and the distal end surfaces 305 and a lower side surface 309 also meet at a right angle. Note that the lower side surface 309 is an example of “side surface”. Thus, edges 302 are formed at the boundaries between the distal end surfaces 305 and the upper side surface 304, and edges 302 are also formed at the boundaries between the distal end surfaces 305 and the lower side surface 309. The boundaries between the distal end surfaces 305 and lateral surfaces are curved surfaces 301. Note that illustrations of reference signs for various portions of the core part 30a are omitted. The core part 30a is produced in the same manner as that for the core part 30b, so that edges 302 are formed at the boundaries between distal end surfaces 305 and an upper side surface 304 and edges 302 are also formed at the boundaries between the distal end surfaces 305 and a lower side surface 309.

The coils 3a, 3b are formed by winding a single flat rectangular wire, and are configured electrically as a single coil 3. Hereinafter, the coils 3a, 3b will be collectively referred to as “coil 3” where appropriate.

The bobbin 20 includes a pair of tubular portions 23 having a quadrangular tubular shape, and a pair of flanges 21, 25. The tubular portions 23 and the flanges 21, 25 are all made of resin. The tubular portions 23 are integral with the flange 25. The tubular portions 23 are coupled to the flange 25 such that the tubular portions 23 are parallel to each other. The flange 25 is provided with slits 25a through which leads 3c of the coil 3 are to be passed. After the coils 3a, 3b are placed around the tubular portions 23, the flange 21 is coupled to distal ends of the tubular portions 23.

Leg portions of the core part 30a having a U-shape are respectively inserted into the tubular portions 23 of the bobbin 20 from the flange 21-side. After spacers 31 are respectively inserted into the tubular portions 23 from the flange 25-side, leg portions of the core part 30b having a U-shape are respectively inserted into the tubular portions 23 of the bobbin 20 from the flange 25-side. Inside the tubular portions 23, the distal end surfaces 305 of the core part 30a face the distal end surfaces 305 of the core part 30b with the spacers 31 interposed therebetween. The shape of a portion of the core 30 disposed inside each tubular portion 23 of the bobbin 20 is a quadrangular prism shape.

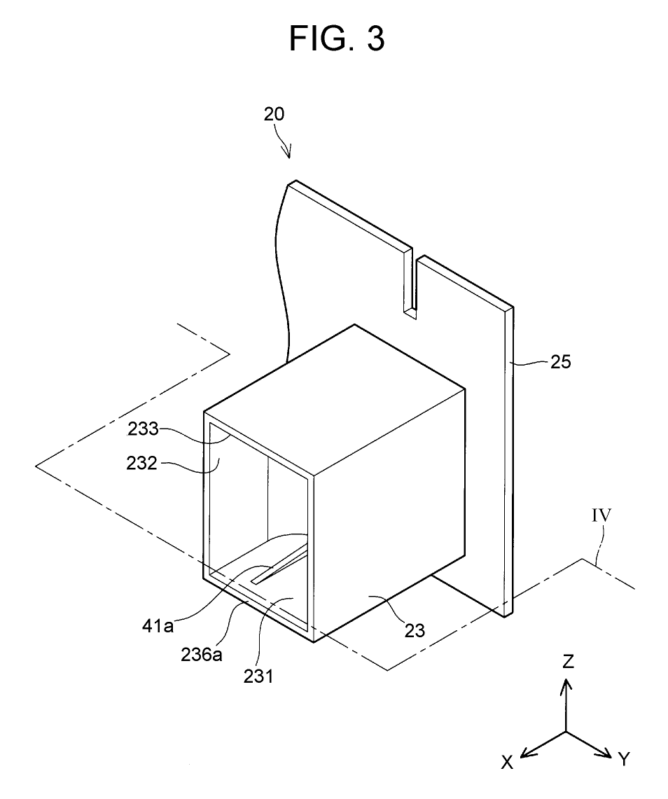

FIG. 3 is an enlarged perspective view of a part of the bobbin 20. FIG. 3 is a perspective view of the tubular portion 23 coupled to the flange 25. FIG. 3 illustrates the bobbin 20 to which the flange 21 illustrated in FIG. 2 has not yet been attached. The X-direction in the drawings corresponds to the axial direction of each tubular portion 23.

A projection 41a is provided on a bottom surface 231 of the tubular portion 23, which is an inner surface of the tubular portion 23. The projection 41a extends along the axis (X-direction) of the tubular portion 23. The height of the projection 41a decreases in a direction toward an opening 236a of the tubular portion 23. Although being hidden and thus not illustrated in FIG. 3, a projection 41a having the same shape as that provided on the bottom surface 231 is provided on an upper surface 233 of the tubular portion 23, which is an inner surface of the tubular portion 23. Each lateral surface 232 of the tubular portion 23, which is an inner surface of the tubular portion 23, is curved such that a center portion thereof in the axial direction of the tubular portion 23 protrudes toward the other lateral surface 232.

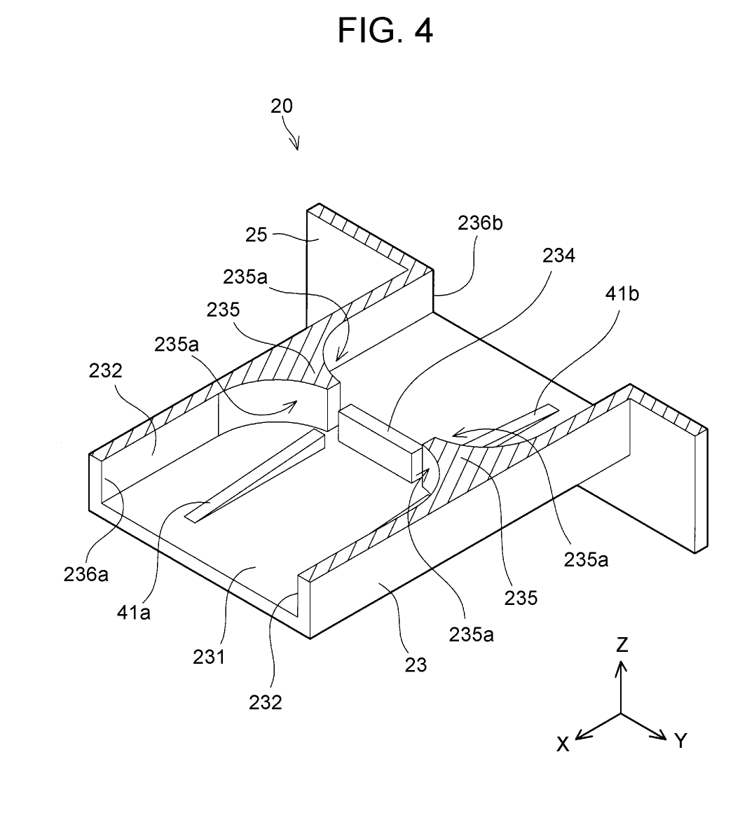

FIG. 4 is a perspective view of the bobbin 20 taken along an alternate long and short dash line IV in FIG. 3. A wall 234 is provided at the center of the bottom surface 231 of the tubular portion 23 in the axial direction (X-direction). A wall 234 having the same shape as that provided on the bottom surface 231 is provided at the center of the upper surface 233. A projection 235 is provided at the center of each lateral surface 232 in the axial direction. At the center of the tubular portion 23 in the axial direction, the inner cross-sectional area of the tubular portion 23 is reduced by the walls 234 and the projections 235. The spacer 31 illustrated in FIG. 2 is fitted in the space defined by the walls 234 and the projections 235.

Each lateral surface 232 is curved so as to approach the other lateral surface 232 as the lateral surface 232 extends toward the center of tubular portion 23 in the axial direction. Thus, each lateral surface 232 has curved surfaces 235a. The curved surfaces 235a face the curved surfaces 301 at the boundaries between the lateral surfaces and the distal end surfaces 305 of the core parts 30a, 30b.

As described above, the projection 41a extending in the axial direction is provided on the bottom surface 231. The projection 41a extends to a position near the center of the tubular portion 23 in the axial direction. The height of the projection 41a decreases in the direction toward the opening 236a. A projection 41b is provided on the bottom surface 231, on an opening 236b-side of the tubular portion 23. The projection 41b extends in the axial direction (X-direction). The height of the projection 41b decreases in a direction toward the opening 236b. Although not illustrated in FIG. 4, the upper surface 233 is provided with projections 41a, 41b having the same shapes as those provided on the bottom surface 231. The projections 41a, 41b provided on the upper surface 233 respectively face the projections 41a, 41b provided on the bottom surface 231.

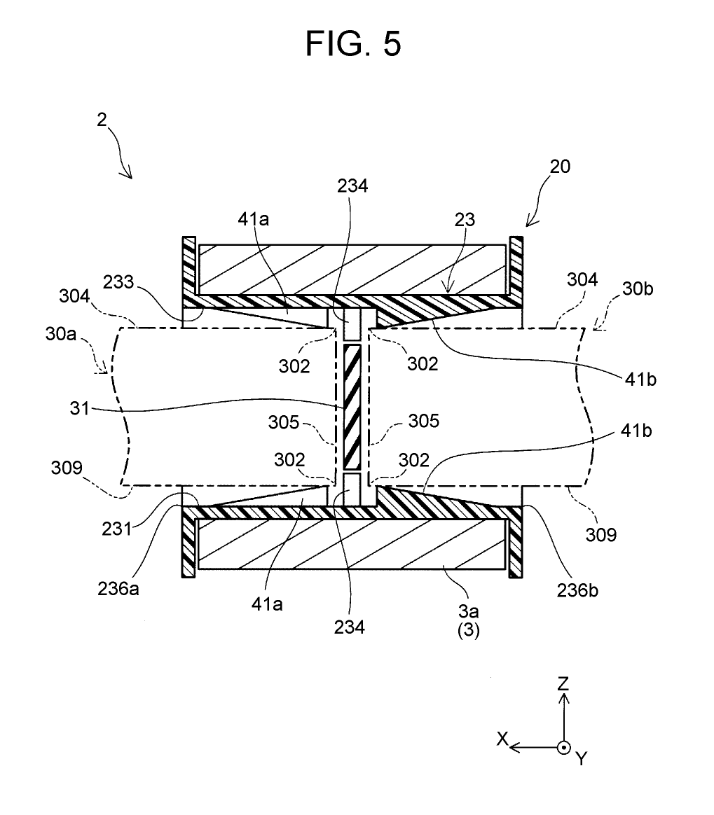

FIG. 5 is a sectional view taken along an alternate long and short dash line V-V line in FIG. 1. The section illustrated in FIG. 5 is a section passing through the projections 41b (see FIG. 4). In FIG. 5, the core parts 30a, 30b are indicated by imaginary lines.

As described above, the spacer 31 is interposed between the wall 234 provided on the bottom surface 231 and the wall 234 provided on the upper surface 233. The bottom surface 231 and the upper surface 233, which face each other, are respectively provided with the projections 41a. The core part 30a is interposed between the projections 41a. The projections 41a are in contact with the core part 30a. As described above, the core part 30a is configured such that the upper side surface 304 is perpendicular to the distal end surfaces 305, and the edges 302 are formed at the boundaries between the upper side surface 304 and the distal end surfaces 305. Similarly, the core part 30a is configured such that the lower side surface 309 is perpendicular to the distal end surfaces 305, and the edges 302 are formed between the lower side surface 309 and the distal end surfaces 305. If the edge 302 comes into contact with the inner surface of the tubular portion 23 in the course of inserting the core part 30a into the tubular portions 23 from the opening 236a-side, the edge 302 may be chipped. The core part 30a is made of a magnetic green-compact formed by mixing magnetic particles with resin and subjecting the mixture to compression-sintering. Thus, the edges 302 may be especially easily chipped. The tubular portion 23 is configured such that the bottom surface 231 and the upper surface 233, which are the inner surfaces facing each other, are respectively provided with the projections 41a extending in the axial direction of the tubular portion 23. The core part 30a is in contact with both of the two projections 41a. The core part 30a is out of contact with the tubular portion 23 except the projections 41a. In the course of inserting the core part 30a into the opening 236a, the upper side surface 304 and the lower side surface 309 of the core part 30a are guided by the projections 41a. This prevents the edges 302 from coming into contact with the tubular portion 23, thereby preventing the edges 302 from being chipped.

Similarly, the projections 41b for the core part 30b are respectively provided on the upper surface 233 and the bottom surface 231 of the tubular portion 23. The projections 41b also extend in the axial direction of the tubular portion 23, and the height of each projection 41b decreases in the direction toward the opening 236b. Both of the two projections 41b are in contact with the core part 30b. The core part 30b is out of contact with the tubular portion 23 except the projections 41b. In the course of inserting the core part 30b into the opening 236b, the upper side surface 304 and the lower side surface 309 of the core part 30b are guided by the projections 41b. This prevents the edges 302 at the boundaries between the distal end surface 305 and the upper and lower side surface 304, 309 from coming into contact with the inner surfaces of the tubular portion 23, thereby preventing the edges 302 from being chipped.

The height of each projection 41a decreases in the direction toward the opening 236a. In the vicinity of the opening 236a, a clearance is left between the core part 30a and each projection 41a. Thus, the core part 30a can be easily inserted into the tubular portion 23. As the core part 30a is moved deeper into the tubular portion 23, the clearance between the core part 30a and each projection 41a decreases, and the core part 30a finally comes into contact with the projections 41a. Because the height of each projection 41a decreases in the direction toward the opening 236a, the core part 30a is smoothly guided by the projections 41a. Thus, the edges 302 of the core part 30a are less likely to be chipped even if the core part 30a comes into contact with the projections 41a. The relationship between the projections 41b and the core part 30b is the same as that between the projections 41a and the core part 30a. Thus, the edges 302 of the core part 30b are also less likely to be chipped.

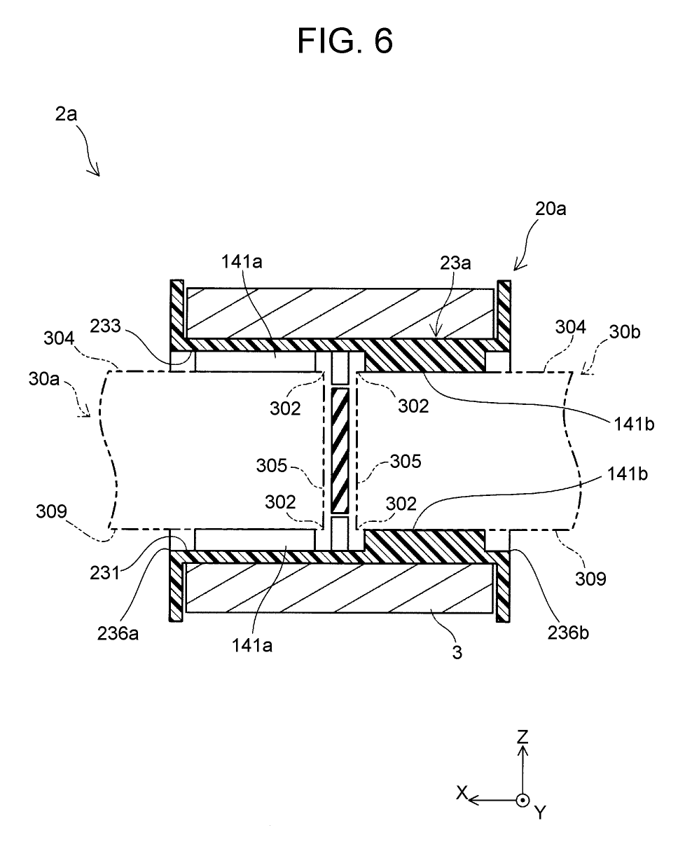

FIG. 6 is a sectional view of a reactor 2a in a first modified example. The sectional view in FIG. 6 corresponds to the sectional view in FIG. 5. In the reactor 2a, projections 141a are respectively provided on the bottom surface 231 and the upper surface 233 of a tubular portion 23a of a bobbin 20a, and projections 141b are respectively provided on the bottom surface 231 and the upper surface 233. The bottom surface 231 and the upper surface 233 face each other. The projections 141a, 141b extend in the axial direction (X-direction in the drawing) of the tubular portion 23a. The core part 30a is interposed between the two projections 141a, and the core part 30b is interposed between the two projections 141b.

In the reactor 2 according to the foregoing embodiment, the height of each projection 41a decreases in the direction toward the opening 236a of the tubular portion 23, and the height of each projection 41b decreases in the direction toward the opening 236b of the tubular portion 23. In contrast to this, in the reactor 2a in the first modified example, the height of each of the projections 141a, 141b remains constant. Preferably, the height of each projection decreases toward the opening, like the projections 41a, 41b of the reactor 2 according to the foregoing embodiment. However, even the reactor 2a in the first modified example can produce an advantageous effect of making it difficult for the edges 302 of the core parts 30a, 30b to be chipped.

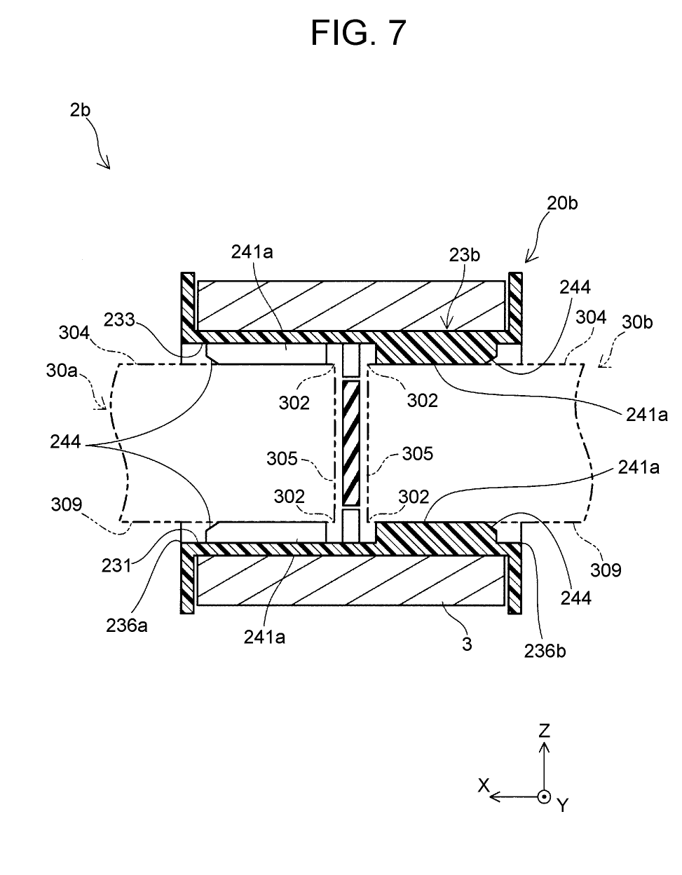

FIG. 7 is a sectional view of a reactor 2b in a second modified example. The sectional view in FIG. 7 corresponds to the sectional view in FIG. 5. In the reactor 2b, projections 241a are respectively provided on the bottom surface 231 and the upper surface 233 of a tubular portion 23b of a bobbin 20b, and projections 241b are respectively provided on the bottom surface 231 and the upper surface 233. The bottom surface 231 and the upper surface 233 face each other. The projections 241a, 241b extend in the axial direction (X-direction in the drawing) of the tubular portion 23a. The core part 30a is interposed between the two projections 241a, and the core part 30b is interposed between the two projections 241b.

In the reactor 2b in the second modified example, the height of each of the projections 241a, 241b remains constant over almost the entire length thereof. However, an end of each projection 241a, which is close to the opening 236a, is chamfered, so that a tilted surface 244 is provided. Similarly, an end of each projection 241b, which is close to the opening 236b, is chamfered, so that a tilted surface 244 is provided. In each projection 241a, the tilted surface 244 of which the height decreases in the direction toward the opening 236a is provided at the end located close to the opening 236a. Similarly, in each projection 241b, the tilted surface 244 of which the height decreases in the direction toward the opening 236b is provided at the end located close to the opening 236b. The reactor 2a in the second modified example can produce an advantageous effect of making it difficult for the edges 302 of the core parts 30a, 30b to be chipped.

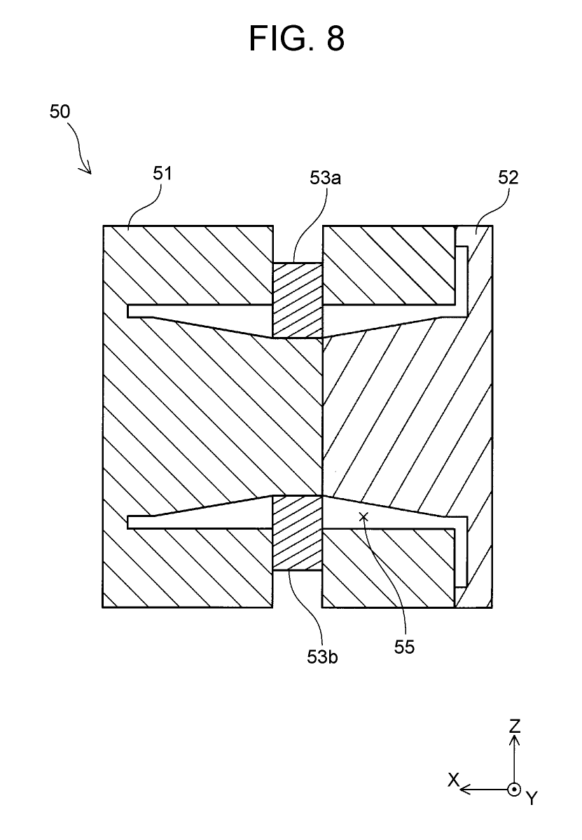

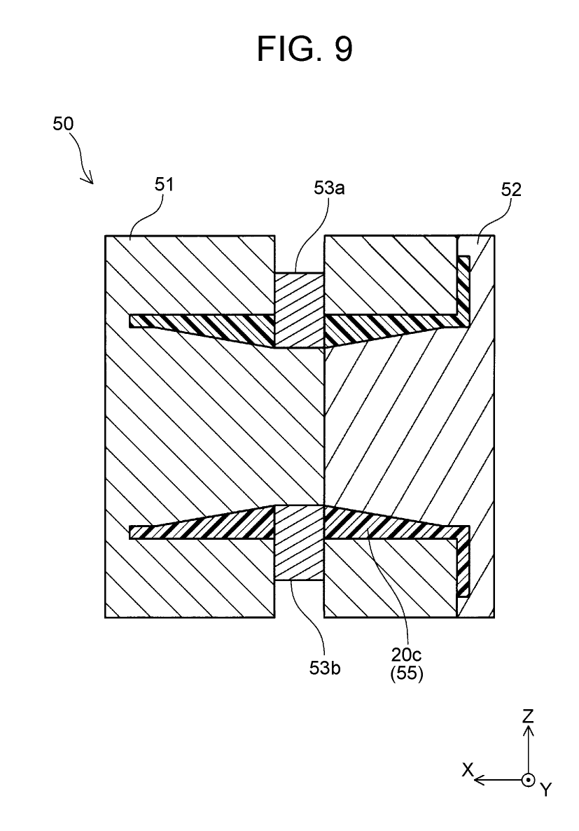

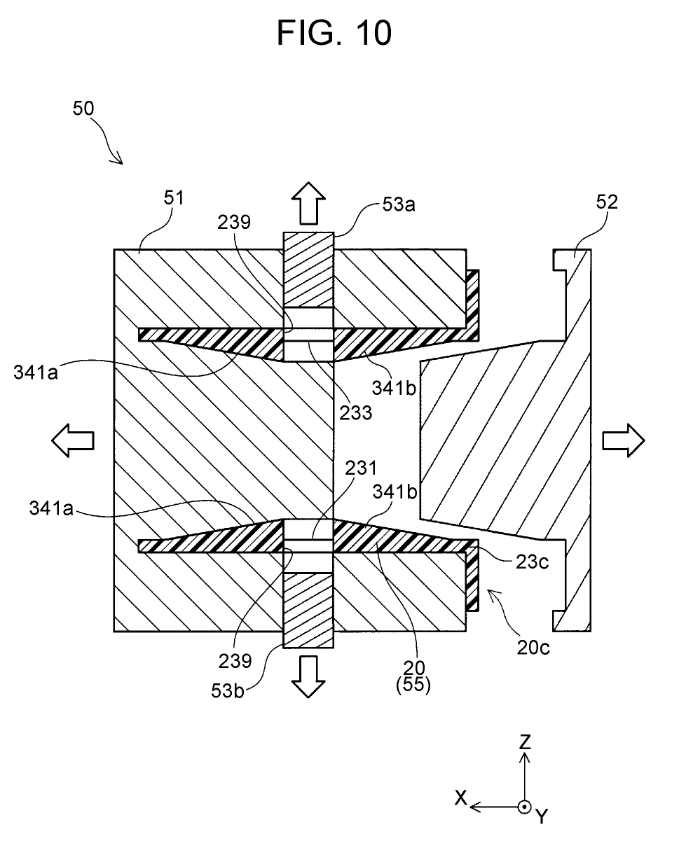

With reference to FIG. 8 to FIG. 10, a bobbin 20c in a third modified example and a method of manufacturing the bobbin 20c will be described. FIG. 8 is a sectional view of a mold 50 for forming the bobbin 20c through injection-molding. FIG. 9 is a sectional view of the bobbin 20c formed, through injection-molding, in a cavity 55 of the mold 50. FIG. 10 is a sectional view of the mold 50 in an opened state and the bobbin 20c. Each of FIG. 8 to FIG. 10 illustrates the bobbin 20c that has not been provided with a flange to be disposed on the left side in the drawings. As described above, the left flange (the flange 21 in FIG. 2) will be attached to the bobbin 20c in a subsequent step.

As illustrated in FIG. 4, in the bobbin 20 according to the foregoing embodiment, the projection 41a provided on the opening 236a-side and the projection 41b provided on the opening 236b-side are not aligned with each other in the axial direction (X-direction) of the tubular portion 23. As illustrated in FIG. 10, in the bobbin 20c in the third embodiment, the projection 341a provided on the left opening-side in the drawing and the protrusion 341b provided on the right opening-side in the drawing are aligned with each other. In this case, portions of the bobbin 20c between the projections 341a and the projections 341b serve as undercuts for the mold 50 for forming a space in a tubular portion. The mold 50 is configured to prevent formation of undercuts between the projections 341a and the projections 341b.

FIG. 8 is a sectional view of the mold 50. The mold 50 includes a left mold 51 and a right mold 52. The left mold 51 includes slide molds 53a, 53b configured to prevent formation of undercuts in the bobbin 20c. The cavity 55 of the mold 50 is in the form of the bobbin 20c.

As illustrated in FIG. 9, molten resin is injected into the cavity 55 to form the bobbin 20c. After the molten resin is hardened, the slide mold 53a is moved upward, and the slide mold 53b is moved downward (FIG. 10). The slide molds 53a, 53b extend through the tubular portion 23c of the bobbin 20c, and regions from which the slide molds 53a, 53b have been removed become through-holes 239 in an upper side surface and a lower side surface of the tubular portion 23c. In the bobbin 20c as a product, the upper and lower side surfaces of the bobbin 20c are provided with the through-holes 239, and the through-holes 239 are provided adjacent to the ends of the projections 341a, 341b, which are located close to the center of the bobbin 20c in the axial direction (X-direction) of the bobbin 20c.

As described above, the bobbin 20c is made of resin and formed through injection-molding. When the bobbin is provided with the projections for two core parts to be inserted into the bobbin from the respective sides of the bobbin, the portions of the bobbin between projections may serve as undercuts for a mold for forming the bobbin through injection-molding (the bobbin 20c). The through-holes 239 provided adjacent to the ends of the projections 341a, 341b, which are located close to the center of the bobbin 20c in the axial direction of the bobbin 20c, are regions into which the slide molds 53a, 53b for preventing formation of undercuts are to be inserted.

A general outline of the technique described in the foregoing embodiment will be described. The reactor according to the foregoing embodiment includes the core having a ring shape, and the tubular portions of the bobbin and the coils are attached to two portions of the core. The technique described in the present specification may also be applied to a reactor including a core in a simple quadrangular prism shape, a bobbin including a single tubular portion, and a single coil.

Concrete examples of the disclosure have been described in detail; however, they are merely examples and do not limit the scope of the claims. The technique described in the claims encompasses various modification and alterations made to the foregoing concrete examples. The technical elements described in the present specification and the drawings exert technical values alone or in various combinations, and are not limited to the combination described in the claims at the time of filing. The techniques exemplified in the present specification or the drawings can achieve multiple purposes simultaneously and are technically valuable by merely achieving one of the purposes.

What is claimed is:

1. A reactor comprising:
a bobbin around which a coil is wound, the bobbin having a tubular shape; and
a core extending through the bobbin, wherein
the core has a quadrangular prism shape, and the core includes a distal end surface and a pair of side surfaces perpendicular to the distal end surface, the side surfaces being opposite surfaces of the core, and
the bobbin includes projections respectively provided on inner surfaces of the bobbin, the inner surfaces of the bobbin respectively facing the side surfaces of the core, the projections extending in an axial direction of a tubular portion of the bobbin, and the projections being in contact with the core.

2. The reactor according to claim 1, wherein a height of each of the projections decreases in a direction toward an opening of the tubular portion.

3. The reactor according to claim 2, wherein:
the core includes at least two core parts that are a first core part and a second core part;
a distal end of the first core part and a distal end of the second core part face each other inside the bobbin; and
the bobbin includes the projections for each of the first core part and the second core part.

4. The reactor according to claim 1, wherein:
the core includes at least two core parts that are a first core part and a second core part;
a distal end of the first core part and a distal end of the second core part face each other inside the bobbin; and
the bobbin includes the projections for each of the first core part and the second core part.
